(19) United States
(12) Patent Application Publication
(10) Pub. No.: US 2017/0256801 A1
(43) Pub. Date: Sep. 7, 2017

(54) NONAQUEOUS ELECTROLYTE SECONDARY BATTERY

(71) Applicant: SANYO Electric Co., Ltd., Daito-shi, Osaka (JP)

(72) Inventors: Masanori Sugimori, Hyogo (JP); Natsumi Goto, Hyogo (JP); Katsunori Yanagida, Hyogo (JP)

(73) Assignee: SANYO Electric Co., Ltd., Daito-shi, Osaka (JP)

(21) Appl. No.: 15/503,842

(22) PCT Filed: Aug. 25, 2015
(86) PCT No.: PCT/JP2015/004237

§ 371 Date: Feb. 14, 2017

(30) Foreign Application Priority Data
Sep. 26, 2014 (JP) 2014-196564

(51) Int. Cl. H01M 4/62; H01M 10/0525; H01M 4/485; H01M 2/16; H01M 4/505; H01M 4/525

(52) U.S. Cl. CPC H01M 4/628; H01M 4/505; H01M 4/525; H01M 4/485; H01M 2/1626; H01M 10/0525

(57) ABSTRACT

Provided is a nonaqueous electrolyte secondary battery in which the generation of gas is suppressed in charge/discharge cycles. The nonaqueous electrolyte secondary battery includes a positive electrode, a negative electrode, a separator placed therebetween, and a nonaqueous electrolyte. The positive electrode includes a positive electrode active material containing a lithium transition metal oxide. The positive electrode contains tungsten oxide. Tungsten is present in the form of a solid solution in the lithium transition metal oxide. Tungsten oxide is attached to the surface of the lithium transition metal oxide. The separator contains cellulose. Tungsten in tungsten oxide contained in the positive electrode is preferably 0.01 mole percent to 3.0 mole percent with respect to transition metals, excluding lithium, in the lithium transition metal oxide.

### TECHNICAL FIELD

The present invention relates to a nonaqueous electrolyte secondary battery.

### BACKGROUND ART

At present, nonaqueous electrolyte secondary batteries are attracting attention as utility power supplies for electric tools, electric vehicles (EVs), hybrid electric vehicles (HEVs and PHEVs), and the like in addition to consumer applications including mobile data terminals such as mobile phones, notebook personal computers, and smartphones and are expected to be more widely used. Such utility power supplies are required to have high capacity so as to be capable of being used for a long time or enhanced output characteristics in the case of repeating large-current charge and discharge in a relatively short time.

Patent Literature 1 proposes a nonaqueous electrolyte secondary battery in which lithium titanate, in which the intercalation-deintercalation reaction of lithium ions occurs at a potential of about 1.5 V versus lithium, that is, a potential nobler than that of a carbon material, is used as a negative electrode active material and cellulose is used for a separator. The nonaqueous electrolyte secondary battery has excellent input-output characteristics and therefore is increasingly expected to be used in novel applications.

Herein, separators are required to be chemically stable to positive electrodes, negative electrodes, and electrolyte solutions and are also required to have good electrolyte permeability and ion permeability. There is a problem in that using cellulose as a separator increases the amount of gas generated in initial use as compared to a microporous membrane made of a common polyolefin. This is because hydroxy groups of cellulose are likely to adsorb moisture by hydrogen bonding and ambient moisture is taken into a battery even if a separator containing cellulose is sufficiently dried. In addition, moisture is produced by the dehydrocondensation of hydroxy groups. Moisture in the battery react with an electrolyte and the like to produce hydrofluoric acid (HF) and therefore causes the decomposition of an electrolyte solution solvent and an active material, thereby increasing the amount of generated gas.

Patent Literature 2 proposes that, in order to suppress the generation of gas, a microporous membrane mainly containing esterified cellulose obtained by esterifying at least one hydroxy group of cellulose is used as a separator.

### CITATION LIST

### Patent Literature

PTL 1: International Publication No. WO 2012/111546

PTL 2: Japanese Published Unexamined Patent Application No. 2003-123724

### SUMMARY OF INVENTION

### Technical Problem

However, it has been difficult to suppress the generation of gas using techniques disclosed in Patent Literatures 1 and 2.

### Solution to Problem

According to an aspect of the present invention, in order to solve the above problem, a nonaqueous electrolyte secondary battery includes a positive electrode, a negative electrode, a separator placed therebetween, and a nonaqueous electrolyte. The positive electrode includes a positive electrode active material containing a lithium transition metal oxide. The positive electrode contains tungsten oxide. Tungsten is present in the form of a solid solution in the lithium transition metal oxide. Tungsten oxide is attached to the surface of the lithium transition metal oxide. The separator contains cellulose.

### Advantageous Effects of Invention

An aspect of the present invention provides a nonaqueous electrolyte secondary battery in which the generation of gas is suppressed in charge/discharge cycles.

### DESCRIPTION OF EMBODIMENTS

An embodiment of the present invention is described below. This embodiment is an example for carrying out the present invention. The present invention is not limited to this embodiment. Appropriate modifications can be made without departing from the gist of the present invention.

(Nonaqueous Electrolyte Secondary Battery)

An example of a nonaqueous electrolyte secondary battery according to an embodiment of the present invention includes a positive electrode capable of intercalating and deintercalating lithium, a negative electrode capable of intercalating and deintercalating lithium, and a nonaqueous electrolyte. The nonaqueous electrolyte secondary battery, which is an example of this embodiment, has a configuration in which an electrode assembly in which the positive electrode and the negative electrode are wound or stacked with a separator therebetween and an electrolyte solution that is a liquid nonaqueous electrolyte are housed in a battery enclosure can. The nonaqueous electrolyte secondary battery is not limited to this configuration. Components of the nonaqueous electrolyte secondary battery are described below in detail.

[Positive Electrode]

The positive electrode includes a positive electrode active material containing a lithium transition metal oxide. Tungsten is present in the form of a solid solution in the lithium transition metal oxide. The positive electrode contains tungsten oxide. Tungsten oxide is attached to the surface of the lithium transition metal oxide.

According to the above configuration, a coating made of a degradation product of the electrolyte solution is formed on the positive electrode active material during charge and discharge in initial use, whereby the corrosion of the positive electrode active material by HF and the dissolution of metal are suppressed. This suppresses the further reaction of a corroded portion of the positive electrode active material with the electrolyte solution, thereby suppressing the generation of an H₂ gas, a CO gas, a CO₂ gas, and the like.

Tungsten oxide is preferably scattered and attached to the surface of the lithium transition metal oxide and more preferably scattered and attached to the surface uniformly.

Examples of tungsten oxide include WO₃, WO₂, and W₂O₃. In particular, WO₃ is preferable because WO₃ has a large valence and a coating is likely to be formed with a small amount of WO₃.

The percentage of a tungsten element in tungsten oxide contained in the positive electrode is preferably 0.01 mole percent to 3.0 mole percent with respect to transition metals, excluding lithium, in the lithium transition metal oxide; more preferably 0.03 mole percent to 2.0 mole percent; and further more preferably 0.05 mole percent to 1.0 mole percent. When the amount of tungsten oxide contained in the positive electrode is small, the suppression of gas generation tends to be insufficient. When the amount of tungsten oxide contained in the positive electrode is too large, the capacity tends to be low. From the viewpoint of readily forming a coating on the lithium transition metal oxide, most of tungsten oxide contained in the positive electrode is preferably attached to the lithium transition metal oxide.

The fact that tungsten is present in the form of a solid solution in the lithium transition metal oxide means a state in which a tungsten element partly substitutes nickel or cobalt in the lithium transition metal oxide and is present in the inside (crystal) of the lithium transition metal oxide.

The percentage of a tungsten element present in the form of a solid solution in the lithium transition metal oxide is preferably 0.01 mole percent to 3.0 mole percent with respect to transition metals, excluding lithium, in the lithium transition metal oxide; more preferably 0.03 mole percent to 2.0 mole percent; and further more preferably 0.05 mole percent to 1.0 mole percent. When the amount of tungsten present in the form of a solid solution is small, the formation of a coating tends to be insufficient. When the amount of tungsten present in the form of a solid solution is too large, the capacity tends to be low.

The fact that tungsten is present in the form of a solid solution in the lithium transition metal oxide and the amount of a solid solution can be confirmed in such a manner that a powder of the lithium transition metal oxide is cut or is surface-ground and the inside of a primary particle is qualitatively and quantitatively analyzed for tungsten by Auger electron spectroscopy (AES), secondary ion mass spectroscopy (SIMS), transmission electron microscope (TEM), energy dispersive X-ray spectroscopy (EDX), or the like.

The following method is cited as a method for forming a solid solution of tungsten in the lithium transition metal oxide: a method for mixing and firing oxides of nickel, cobalt, and manganese; a lithium compound such as lithium hydroxide or lithium carbonate; and a tungsten compound such as tungsten oxide. The firing temperature is preferably 650° C. to 1,000° C. and more preferably 700° C. to 950° C. This is because when the firing temperature is lower than 650° C., the decomposition reaction of lithium hydroxide is insufficient and is unlikely to proceed and when the firing temperature is 1,000° C. or higher, cation mixing is significant and inhibits the diffusion of Li⁺, the specific capacity is therefore reduced, and load characteristics are poor.

The following methods are cited as a method for attaching tungsten oxide to the surface of the lithium transition metal oxide in the positive electrode: a method in which the lithium transition metal oxide and tungsten oxide are mechanically mixed together in advance and are attached to each other and a method in which tungsten oxide is added in a step of kneading a conductive agent and a binder.

Particles with an average size of 2 μm to 30 μm are cited as the lithium transition metal oxide. The particles may be secondary particles composed of primary particles with a size of 100 nm to 10 μm. In the present invention, the average particle size can be determined with, for example, a scattering particle size distribution analyzer (manufactured by HORIBA).

The average particle size of tungsten oxide is preferably less than the average particle size of the lithium transition metal oxide and more preferably less than one-fourth thereof. When tungsten oxide is larger than the lithium transition metal oxide, the contact area with the lithium transition metal oxide is small and an effect may possibly not be sufficiently exhibited.

As the lithium transition metal oxide, those containing at least one selected from the group consisting of, for example, nickel (Ni), manganese (Mn), and cobalt (Co) as a transition metal are cited. The lithium transition metal oxide may contain a non-transition element such as aluminium (Al) or magnesium (Mg). Lithium cobaltate, a Ni—Co—Mn-based lithium transition metal oxide, a Ni—Co—Al-based lithium transition metal oxide, a Ni—Mn—Al-based lithium transition metal oxide, and the like are cited as examples. The following oxide may be used as the lithium transition metal oxide: an olivine-type lithium transition metal composite oxide (represented by LiMPO₄, where M is selected from Fe, Mn, Co, and Ni) containing iron (Fe), manganese (Mn), or the like. These oxides may be used alone or in combination.

Among the above oxides, the Ni—Co—Mn-based lithium transition metal oxide is particularly preferably used. This is because the Ni—Co—Mn-based lithium transition metal oxide has excellent output characteristics and regenerative characteristics. As examples of the Ni—Co—Mn-based lithium transition metal oxide, those having a Ni-to-Co-to-Mn molar ratio of 1:1:1, 5:2:3, 4:4:2, 5:3:2, 6:2:2, 55:25:20, 7:2:1, 7:1:2, or 8:1:1 and the like can be used. In particular, in order to allow the positive electrode to have increased capacity, one in which the percentage of Ni or Co is higher than that of Mn is preferably used. In particular, one in which the difference between the molar ratio of Ni to the sum of moles of Ni, Co, and Mn and the molar ratio of Mn to the sum thereof is 0.04% or more is preferable.

As examples of the Ni—Co—Al-based lithium transition metal oxide, those having a Ni-to-Co-to-Al ratio of 82:15:3, 82:12:6, 80:10:10, 80:15:5, 87:9:4, 90:5:5, or 95:3:2 and the like can be used.

The lithium transition metal oxide may contain an additive element. Examples of the additive element include boron, magnesium, aluminium, titanium, vanadium, iron, copper, zinc, niobium, zirconium, tin, tantalum, sodium, potassium, barium, strontium, and calcium.

The positive electrode active material is not limited to the case of using particles of the positive electrode active material alone. The positive electrode active material can be used in combination with another positive electrode active material. This positive electrode active material is not particularly limited and may be a compound capable of reversibly intercalating and deintercalating lithium ions. For example, those, such as lithium cobaltate and lithium nickel-cobalt-manganate, capable of intercalating and deintercalating lithium ions with a stable crystal structure maintained and having a layered structure; those, such as lithium manganese oxides and lithium nickel manganese oxides, having a spinel structure; those having an olivine structure; and the like can be used. In the case of using the same type or different types of positive electrode active materials, the positive electrode active materials used may have the same particle size or different particle sizes.

The positive electrode, which contains the positive electrode active material, is preferably composed of a positive electrode current collector and a positive electrode mix layer formed on the positive electrode current collector. The positive electrode mix layer preferably contains the positive electrode active material particles, a binder, and a conductive agent. The positive electrode current collector used is, for example, a conductive thin film, particularly metal or alloy foil, such as aluminium, stable in the potential range of the positive electrode or a film including a metal surface layer made of aluminium or the like.

A fluorinated polymer, a rubber polymer, and the like are cited as the binder. Examples of the fluorinated polymer include polytetrafluoroethylene (PTFE), polyvinylidene fluoride (PVdF), and modifications of these polymers. Examples of the rubber polymer include ethylene-propylene-isoprene copolymers and ethylene-propylene-butadiene copolymers. These copolymers may be used alone or in combination. The binder may be used in combination with a thickening agent such as carboxymethylcellulose (CMC) or polyethylene oxide (PEO).

Examples of the conductive agent include carbon materials such as carbon black, acetylene black, Ketjenblack, graphite, vapor-grown carbon (VGCF), carbon nanotubes, and carbon nanofibers. These carbon materials may be used alone or in combination.

[Separator]

The separator according to the embodiment of the present invention contains cellulose. Since cellulose contains hydroxy groups in its structural formula, hydroxy groups are present in the separator, which contains cellulose, and the separator contains adsorbed moisture. Therefore, using the separator, which contains cellulose, in combination with the positive electrode suppresses the corrosion of the positive electrode active material by HF and the dissolution of metal and also suppresses the generation of gas in cycles.

Examples of cellulose include regenerated fibers such as rayon. In the case of being used as the separator, one that is fibrillated and then subjected to papermaking is preferable.

The separator, which contains cellulose, may contain a binder such as a polyethylene fiber, a polyvinyl alcohol fiber, or a polyester fiber. The separator, which contains cellulose, may contain a binder such as a polyvinyl alcohol resin, an acrylic resin, an epoxy resin, or a phenol resin.

The separator, which contains cellulose, may contain filler. Examples of the filler include inorganic substances such as oxides containing one or more of titanium, aluminium, silicon, magnesium, and the like and resins such as polypropylene.

The separator, which contains cellulose, preferably has a thickness of 10 μm to 50 μm. The separator, which contains cellulose, may be single- or multi-layered.

A layer made of an inorganic filler may be formed at the interface between the positive electrode and the separator or the interface between the negative electrode and the separator. An oxide containing one or more of titanium, aluminium, silicon, magnesium, and the like; a phosphate compound; one surface-treated with a hydroxide; or the like can be used as filler.

[Negative Electrode]

A conventionally used negative electrode active material can be used as a negative electrode active material used in the negative electrode of the nonaqueous electrolyte secondary battery according to the present invention. A carbon material capable of intercalating and deintercalating lithium, a metal capable of being alloyed with lithium, an alloy compound containing the metal, or lithium titanate is cited.

Lithium titanate is preferably used as the negative electrode active material. In particular, lithium titanate having a spinel crystal structure is preferably used. As an example of lithium titanate having the spinel crystal structure, Li_{4+X}Ti₅O₁₂ (0≦X≦3) is cited. The fact that lithium titanate has the spinel structure can be readily confirmed by X-ray diffraction or the like.

In lithium titanate, Ti elements in lithium titanate may be partially substituted with one or more types of elements different from Ti. Partially substituting Ti elements in a lithium-containing titanium oxide with one or more types of elements different from Ti enables a negative electrode-regulated nonaqueous electrolyte secondary battery having an irreversible capacity rate larger than that of the lithium-containing titanium oxide to be achieved.

Particles with an average particle size of 0.1 μm to 10 μm are cited as lithium titanate.

In the case of using lithium titanate as the negative electrode active material, fluorinated graphite is preferably contained in a negative electrode mix. When fluorinated graphite is contained in the negative electrode mix, a nonaqueous electrolyte secondary battery in which the battery voltage reaches the final voltage depending on the change in potential of a negative electrode can be obtained. Thus, the decomposition reaction of an electrolyte solution due to the change in potential of a positive electrode can be reduced and therefore the amount of generated gas can be reduced.

The negative electrode, which contains the negative electrode active material, is obtained in such a manner that, for example, the negative electrode active material and a binder are mixed with water or an appropriate solvent, the mixture is applied to a negative electrode current collector and is dried, and the negative electrode current collector is rolled. The negative electrode current collector used is preferably a conductive thin film, metal or alloy foil stable in the potential range of the negative electrode, a film including a metal surface layer, or the like. In the case of using lithium titanate as the negative electrode active material, aluminium foil is preferable. For example, copper foil, nickel foil, stainless steel foil, or the like may be used. The negative electrode current collector may have substantially the same shape as that of the positive electrode current collector.

[Nonaqueous Electrolyte]

The following carbonates can be used as a solvent for the nonaqueous electrolyte: cyclic carbonates such as ethylene carbonate, propylene carbonate, butylene carbonate, and vinylene carbonate and linear carbonates such as dimethyl carbonate, ethyl methyl carbonate, and diethyl carbonate. Those obtained by partially or entirely fluorinating hydrogen of these carbonates can be used. In particular, in order to suppress the generation of gas, a cyclic carbonate is preferably contained. When the cyclic carbonate is contained, a good coating is formed on the surface of the lithium transition metal oxide. Therefore, the corrosion of the positive electrode active material by HF and the dissolution of metal are suppressed and the generation of gas in cycles is suppressed.

Propylene carbonate is preferably used as the cyclic carbonate. Propylene carbonate is unlikely to be decomposed and therefore the generation of gas is reduced. Using propylene carbonate allows excellent low-temperature input-output characteristics to be obtained. In the case of using the carbon material as the negative electrode active material, when propylene carbonate is contained, an irreversible charge reaction may possibly occur. Therefore, ethylene carbonate or fluoroethylene carbonate is preferably used together with propylene carbonate. In the case of using lithium titanate as the negative electrode active material, such an irreversible charge reaction is unlikely to occur. Therefore, the percentage of propylene carbonate in the cyclic carbonate is preferably high. The percentage of propylene carbonate in the cyclic carbonate is preferably, for example, 80% or more and more preferably 90% or more.

A solvent mixture of the cyclic carbonate and a linear carbonate is preferably used as a nonaqueous solvent having low viscosity, a low melting point, and high lithium ion conductivity. Furthermore, the volume ratio of the cyclic carbonate to the linear carbonate in the solvent mixture is preferably regulated in the range of 2:8 to 5:5.

The following compounds can be used together with the solvent: ester-containing compounds such as methyl acetate, ethyl acetate, propyl acetate, methyl propionate, ethyl propionate, and γ-butyrolactone. The following compounds can be used together with the solvent: sulfo group-containing compounds such as propanesultone and ether-containing compounds such as 1,2-dimethoxyethane, 1,2-diethoxyethane, tetrahydrofuran, 1,3-dioxane, 1,4-dioxane, and 2-methyltetrahydrofuran. The following compounds can be used together with the solvent: nitrile-containing compound such as butyronitrile, valeronitrile, n-heptanenitrile, succinonitrile, glutaronitrile, adiponitrile, pimelonitrile, 1,2,3-propanetricarbonitrile, and 1,3,5-pentanetricarbonitrile; amide-containing compounds such as dimethylformamide; and the like. Solvents obtained by partially substituting hydrogen atoms H of these compounds with fluorine atoms F can be used.

On the other hand, the following compounds can be used as a solute for the nonaqueous electrolyte: for example, LiPF₆, LiBF₄, LiCF₃SO₃, LiN(FSO₂)₂, LiN(CF₃SO₂)₂, LiN(C₂F₅SO₂)₂, LiN(CF₃SO₂)(C₄F₉SO₂), LiC(C₂F₅SO₂)₃, and LiAsF₆. Furthermore, those obtained by adding lithium salts (lithium salts (for example, LiClO₄, LiPO₂F₂, and the like) containing one or more of P, B, O, S, N, and Cl) other than fluorine-containing lithium salts to the fluorine-containing lithium salts may be used. In particular, using an electrolyte salt containing an F element in its structural formula further suppresses the corrosion of the positive electrode active material by HF and the dissolution of metal.

### EXAMPLES

Examples of the present invention are described below in detail with reference to experiment examples. The present invention is not limited to the examples.

Appropriate modifications can be made without departing from the gist of the present invention.

### Experiment 1

### Experiment Example 1

[Preparation of positive electrode active material] A hydroxide, represented by [Ni_{0.5}Co_{0.20}Mn_{0.30}](OH)₂, obtained by coprecipitation was fired at 500° C., whereby a nickel-cobalt-manganese composite oxide was obtained. Next, lithium carbonate, the nickel-cobalt-manganese composite oxide obtained as described above, and tungsten oxide (WO₃) were mixed together in an Ishikawa-type Raikai mortar such that the molar ratio of lithium to the total amount of nickel, cobalt, and manganese to tungsten was 1.20:1:0.005. Thereafter, the mixture was heat-treated at 900° C. for 20 hours in an air atmosphere and was then crushed, whereby a lithium-nickel-manganese-cobalt composite oxide, represented by Li_{1.07}[Ni_{0.465}Co_{0.186}Mn_{0.279}]O₂, containing tungsten in the form of a solid solution was obtained. An obtained powder was observed with a scanning electron microscope (SEM), whereby it was confirmed that no unreacted tungsten oxide (WO₃) remained.

Li_{1.07}[Ni_{0.465}Co_{0.186}Mn_{0.279}]O₂ containing tungsten in the form of a solid solution and tungsten oxide (WO₃) were mixed together using HIVIS DISPER MIX (manufactured by PRIMIX Corporation), whereby a positive electrode active material was prepared. In this operation, mixing was performed such that the molar ratio of the total amount of nickel, cobalt, and manganese in Li_{1.07}[Ni_{0.465}Co_{0.186}Mn_{0.279}]O₂ to tungsten in tungsten oxide (WO₃) was 1:0.05. In the obtained positive electrode active material, the molar ratio of the total amount of nickel, cobalt, and manganese to tungsten in the form of a solid solution to tungsten contained in the form of tungsten oxide was 1:0.005:0.005.

[Preparation of Positive Electrode Plate]

The positive electrode active material, acetylene black serving as a conductive agent, and polyvinylidene fluoride serving as a binder were weighed such that the mass ratio of the positive electrode active material to acetylene black to polyvinylidene fluoride was 93.5:5:1.5, followed by adding N-methyl-2-pyrrolidone serving as a dispersion medium. These were kneaded, whereby positive electrode mix slurry was prepared. Next, the positive electrode mix slurry was applied to both surfaces of a positive electrode current collector composed of aluminium foil, this was dried and was then rolled using a rolling roller, and a current-collecting tab made of aluminium was attached thereto, whereby a positive electrode plate including the positive electrode current collector and positive electrode mix layers formed on both surfaces of the positive electrode current collector was prepared. Observing the obtained positive electrode plate with a scanning electron microscope (SEM) showed that tungsten oxide particles with an average size of 150 nm were attached to the surfaces of particles of the lithium-nickel-manganese-cobalt composite oxide.

[Preparation of Negative Electrode Active Material]

Source powders of LiOH.H₂O and TiO₂, which are commercially available reagents, were weighed such that the Li/Ti molar mixing ratio was slightly richer in Li than the stoichiometric ratio, followed by mixing these powders in a mortar. The raw material TiO₂ used was one having an anatase crystal structure. The mixed source powders were put in a crucible made of Al₂O₃ and were heat-treated at 850° C. for 12 hours in an air atmosphere, whereby Li₄Ti₅O₁₂ was obtained.

The heat-treated material was taken out of the crucible and was then crushed in a mortar, whereby a coarse powder of Li₄Ti₅O₁₂ was obtained. The obtained Li₄Ti₅O₁₂ coarse powder was measured with a powder X-ray diffractometer (manufactured by Rigaku Corporation), whereby a diffraction pattern of a single phase having a spinel structure with a space group assigned to Fd3m was obtained.

The obtained Li₄Ti₅O₁₂ coarse powder was jet-milled and was then classified. The observation of an obtained powder with a scanning electron microscope (SEM) confirmed that the coarse powder was milled into single particles with a size of about 0.7 μm.

[Preparation of Negative Electrode Plate]

Li₄Ti₅O₁₂ obtained by the above method, acetylene black serving as a conductive agent, polyvinylidene fluoride serving as a binder, and fluorinated graphite ((CF)ₙ produced by Daikin Industries, Ltd.) serving as an additive were weighed such that the mass ratio of Li₄Ti₅O₁₂ to acetylene black to PVdF to (CF)ₙ was 100:7:3:2.33, followed by adding N-methyl-2-pyrrolidone serving as a dispersion medium. These were kneaded, whereby negative electrode mix slurry was prepared. Next, the negative electrode mix slurry was applied to both surfaces of a negative electrode current collector composed of aluminium foil, this was dried and was then rolled using a rolling roller, and a current-collecting tab made of aluminium was attached thereto, whereby a negative electrode plate including the negative electrode current collector and negative electrode mix layers formed on both surfaces of the negative electrode current collector was prepared.

[Preparation of Nonaqueous Electrolyte]

LiPF₆ serving as a solute was dissolved in a solvent mixture of PC (propylene carbonate), EMC (ethyl methyl carbonate), and DMC (dimethyl carbonate) mixed at a volume ratio of 25:35:40 at a rate of 1.2 moles per liter.

[Preparation of Battery]

The positive electrode and negative electrode obtained in this way were wound with a separator made of cellulose therebetween so as to face each other, whereby a roll was prepared. After the roll was vacuum-dried at 105° C. for 150 minutes, the roll was sealed in an aluminium laminate together with the nonaqueous electrolyte in a glove box under an argon atmosphere, whereby Battery A1 was prepared. The design capacity of Battery A1 was 18.5 mAh.

### Experiment Example 2

Battery A2 was prepared in substantially the same manner as that used in Experiment Example 1 except that WO₃ was not mixed with Li_{1.07}[Ni_{0.465}Co_{0.186}Mn_{0.279}]O₂ containing tungsten in the form of a solid solution.

### Experiment Example 3

Battery A3 was prepared in substantially the same manner as that used in Experiment Example 1 except that in the preparation of a positive electrode active material, WO₃ was not added when a mixture is heat-treated at 900° C. for 20 hours in an air atmosphere, that is, a solid solution of tungsten was not formed in Li_{1.07}[Ni_{0.465}Co_{0.186}Mn_{0.279}]O₂.

### Experiment Example 4

Battery A4 was prepared in substantially the same manner as that used in Experiment Example 1 except that in the preparation of a positive electrode active material, a solid solution of tungsten was not formed in Li_{1.07}[Ni_{0.465}Co_{0.186}Mn_{0.279}]O₂ or WO₃ was not mixed with obtained Li_{1.07}[Ni_{0.465}Co_{0.186}Mn_{0.279}]O₂.

### Experiment

(Charge-Discharge Conditions)

Each of Batteries A1 to A4 was charged and discharged for 25 cycles under conditions below.

(Charge-Discharge Conditions)

Charge-discharge conditions in the first cycle: Constant-current charge was performed at a charge current of 0.19 lt (3.5 mA) under 25° C. temperature conditions until the voltage of each battery reached 2.65 V. Next, constant-current discharge was performed at a discharge current of 0.19 lt (3.5 mA) until the battery voltage reached 1.5 V.

Charge-discharge conditions in the second to 25th cycles: Constant-current charge was performed at a charge current of 1.95 lt (36 mA) under 25° C. temperature conditions until the battery voltage reached 2.65 V and constant-voltage charge was further performed at a constant voltage of 2.65 V until the current reached 0.03 lt (0.5 mA). Next, each cell was discharged to 1.5 V at a discharge current of 1.95 lt (36 mA) in a constant current mode. Incidentally, the interval between the charge and the discharge was 10 minutes.

(Calculation of amount of generated gas) The difference between the mass of each battery in air and the mass of the battery in water was measured on the basis of the Archimedes method before charge and discharge and after 25 cycles of charge and discharge and the buoyant force (volume) acting on the battery was calculated. The difference between the buoyant force before a charge-discharge test and the buoyant force after a 25-cycle charge-discharge test was defined as the amount of generated gas.

TABLE 1

| | Positive electrode active material | | | Amount of |
|---|---|---|---|---|
| | Tungsten solid | Attached tungsten | Separator | generated gas |
| Battery | solution | oxide | type | (cm³) |
| A1 | Present | Present | Cellulose | 2.74 |
| A2 | Present | Absent | Cellulose | 2.97 |
| A3 | Absent | Present | Cellulose | 2.84 |
| A4 | Absent | Absent | Cellulose | 2.80 |

In the case of using the separators made of cellulose, Battery A1, in which tungsten was present in the form of a solid solution in the positive electrode active material and the positive electrode active material having tungsten oxide attached to the surface thereof was used, had a smaller amount of generated gas as compared to Battery A4, in which no tungsten was present in the form of a solid solution or tungsten oxide was not attached. On the other hand, the following batteries had a larger amount of generated gas as compared to Battery A4: Battery A2, in which the positive electrode active material in which tungsten was present in the form of a solid solution and the separator made of cellulose were used, and Battery A3, in which the positive electrode active material having tungsten oxide attached thereto and the separator made of cellulose were used.

It is conceivable that, in Batteries A1 to A3, the oxidative degradation of an electrolyte solution on the lithium-nickel-cobalt-manganese composite oxide was promoted by the catalysis of tungsten and a coating of a degradation product was formed. It is conceivable that, in Battery A1, a coating of a degradation product having a high function of protecting the positive electrode active material from HF was formed and therefore the amount of generated gas was small. On the other hand, it is conceivable that, in Batteries A2 and A3, as well as Battery A1, though the degradation product coating was formed on the positive electrode active material, the reaction of the positive electrode active material with HF was not suppressed by this coating and the amount of generated gas was increased.

It is conceivable that, in Battery A4, the formation of a coating did not proceed, the positive electrode active material was therefore corroded by HF, and the generation of gas could not be suppressed.

In Batteries A1 to A4, lithium titanate was used as the positive electrode active material. It is deduced that, even if a carbon material such as graphite is used as the positive electrode active material, a similar trend appears. However, since lithium titanate adsorbs a larger amount of water as compared to the carbon material, it is conceivable that the use of lithium titanate further exhibits the effect of suppressing the generation of gas.

### Reference Experiment 1

### Experiment Example 5

Battery B1 was prepared in substantially the same manner as that used in Experiment Example 1 except that a microporous membrane mainly containing polypropylene and polyethylene was used as a separator.

### Experiment Example 6

Battery B2 was prepared in substantially the same manner as that used in Experiment Example 2 except that a microporous membrane mainly containing polypropylene and polyethylene was used as a separator.

### Experiment Example 7

Battery B3 was prepared in substantially the same manner as that used in Experiment Example 3 except that a microporous membrane mainly containing polypropylene and polyethylene was used as a separator.

### Experiment Example 8

Battery B4 was prepared in substantially the same manner as that used in Experiment Example 4 except that a microporous membrane mainly containing polypropylene and polyethylene was used as a separator.

### Experiment

For Batteries B1 to B4, the amount of generated gas was calculated after 25 cycles of charge and discharge in the same manner as that used in Experiment Example 1.

TABLE 2

| | Positive electrode active material | | | Amount of |
|---|---|---|---|---|
| | Tungsten solid | Attached tungsten | Separator | generated gas |
| Battery | solution | oxide | type | (cm³) |
| B1 | Present | Present | Polyolefin | 0.35 |
| B2 | Present | Absent | Polyolefin | 0.37 |
| B3 | Absent | Present | Polyolefin | 0.35 |
| B4 | Absent | Absent | Polyolefin | 0.32 |

In the case of using the separators made of cellulose, the amount of gas generated in Battery A1 was small in comparisons between Batteries A1, A2, and A3. In the case of using the separators made of the polyolefins, there was no difference in the amount of generated gas between Batteries B1, B2, and B3. The amount of gas generated in Battery B4 was smallest.

It is conceivable that, in Batteries B1 to B3, as well as Batteries A1 to A3, the oxidative degradation of an electrolyte solution on the lithium-nickel-cobalt-manganese composite oxide is promoted by the catalysis of tungsten and gas is generated when a coating of a degradation product is formed. Herein, though the coating formed in Battery B1 is more likely to protect the positive electrode active material from HF as compared to the coating of the degradation product formed in each of Batteries B2 and B3, no separator made of cellulose is used in Batteries B1 to B3. Therefore, the amount of moisture entering the inside of each battery is small and the production of HF is low. Hence, it is conceivable that there is no difference in the amount of generated gas between the batteries.

In Battery B4, the positive electrode contains no tungsten. Therefore, the formation reaction of the degradation product due to the oxidative degradation of the electrolyte solution and the generation of gas during the formation of the degradation product are lower as compared to those in Batteries B1 to B3. Hence, it is conceivable that the amount of gas generated in Battery B4 is smallest.

From Tables 1 and 2, it is clear that the amount of generated gas specifically decreases only in the case where the separator made of cellulose is used, tungsten is present in the form of a solid solution in the positive electrode active material, and tungsten oxide is present on the surface of the positive electrode active material.

Batteries B1 to B4, in which the separators made of the polyolefins are used, have a very small amount of generated gas as compared to Batteries A1 to A4, in which the separators made of cellulose are used. This is probably because very few hydroxy groups are present on the separators made of the polyolefins and therefore the amount of moisture taken into the batteries is small. Incidentally, in the case of using a separator made of a polyolefin, more excellent output characteristics are not obtained as compared to those obtained using a separator made of cellulose.

1. A nonaqueous electrolyte secondary battery comprising a positive electrode, a negative electrode, a separator placed between the positive electrode and the negative electrode, and a nonaqueous electrolyte,
wherein the positive electrode includes a positive electrode active material containing a lithium transition metal oxide,
the positive electrode contains tungsten oxide,
tungsten is present in the form of a solid solution in the lithium transition metal oxide, tungsten oxide is attached to the surface of the lithium transition metal oxide, and
the separator contains cellulose.

2. The nonaqueous electrolyte secondary battery according to claim 1, wherein a tungsten element in tungsten oxide contained in the positive electrode is 0.01 mole percent to 3.0 mole percent with respect to transition metals, excluding lithium, in the lithium transition metal oxide.

3. The nonaqueous electrolyte secondary battery according to claim 1, wherein a tungsten element present in the form of a solid solution in the lithium transition metal oxide is 0.01 mole percent to 3.0 mole percent with respect to the transition metals, excluding lithium, in the lithium transition metal oxide.

4. The nonaqueous electrolyte secondary battery according to claim 1, wherein the tungsten oxide includes WO₃.

5. The nonaqueous electrolyte secondary battery according to claim 1, wherein the lithium transition metal oxide contains nickel, cobalt, and manganese.

6. The nonaqueous electrolyte secondary battery according to claim 1, wherein the negative electrode contains lithium titanate.
